(19) United States
(12) Patent Application Publication
(10) Pub. No.: US 2025/0013550 A1
(43) Pub. Date: Jan. 9, 2025

(54) SYSTEM DESIGN DEVICE, DISPLAY DEVICE, SYSTEM DESIGN METHOD, AND RECORDING MEDIUM

(71) Applicant: NEC Corporation, Minato- ku, Tokyo (JP)

(72) Inventor: Takayuki Kuroda, Tokyo (JP)

(73) Assignee: NEC Corporation, Minato- ku, Tokyo (JP)

(21) Appl. No.: 18/711,679

(22) PCT Filed: Dec. 9, 2021
(86) PCT No.: PCT/JP2021/045353

§ 371 Date: May 20, 2024

(51) Int. Cl. G06F 11/34; G06F 11/32

(52) U.S. Cl. CPC G06F 11/3452; G06F 11/324; G06F 11/3438

(57) ABSTRACT

A system design device estimates a probability distribution of values of evaluation indices of an embodied system configuration in cases where system configurations that are candidates to be embodied have been embodied in system design involving embodiment of system configurations; calculates expected values of the evaluation indices on the basis of the probability distribution; and selects one of the system configurations that is a candidate to be embodied on the basis of the expected values of the evaluation indices and embodies the selected system configuration.

### TECHNICAL FIELD

The present invention relates to a system design device, a display device, a system design method, and a recording medium.

### BACKGROUND ART

Several techniques have been proposed for the automatic design of systems such as ICT (Information And Communication Technology) systems.

For example, Non-Patent Document 1 shows a system design method that derives a fully embodied configuration by repeating the operation of embodying the content of input requirements by rewriting them according to pre-given conversion rules.

Non-Patent Document 2 also describes narrowing down the system configuration to be embodied based on constraint conditions to be satisfied by quantitative evaluation indices, such as the performance required of constituent elements of a system. Specifically, in the system design method described in Non-Patent Document 2, if multiple constraint conditions presented in one system configuration are incompatible, the system configuration is excluded from the embodiment.

### PRIOR ART DOCUMENTS

### Non Patent Documents

Non-Patent Document 1: Kuroda, T., Kuwahara T., Maruyama, T., Yaguchi, Y., Tanabe, K., Fukuda, T., Satoda, K., and Osaki, T., “Acquisition of Knowledge about ICT System Designing with Machine Learning,” 2021 IEICE Transactions on Communications (Japanese Edition), Vol. J104-B, No. 3, pp. 140-151.
Non-Patent Document 2: Kuwahara, T., Kuroda, T., Osaki, T., and Satoda, K., “An Intent-based System Configuration Design for IT/NW Services with Functional and Quantitative Constraints”, 2021 IEICE Transactions on Communications, Vol. E104.B, Issue 7, pp. 791-804.

### SUMMARY OF THE INVENTION

### Problems to be Solved by the Invention

The system configuration resulting from the system design should satisfy the specified constraint conditions and also satisfy the constraint conditions at as high a level as possible with respect to the performance desired by the users.

An example of an object of this disclosure is to provide a system design device, a display device, a system design method, and a recording medium capable of solving the above-mentioned problems.

### Means for Solving the Problem

According to the first example aspect of the present invention, a system design device is provided with: a probability distribution estimation means that estimates a probability distribution of values of evaluation indices of an embodied system configuration in cases where system configurations that are candidates to be embodied have been embodied in system design involving embodiment of system configurations; an expected value calculation means that calculates expected values of the evaluation indices on the basis of the probability distribution; and a system configuration embodiment means that selects one of the system configurations that is a candidate to be embodied on the basis of the expected values of the evaluation indices, and embodies the selected system configuration.

According to the second example aspect of the present invention, the display device displays a user operation area for accepting input of a weight value for each of a plurality of evaluation indices for the system configuration generated by system design.

According to the third example aspect of the present invention, the display device displays an icon for accepting a user operation to indicate whether or not to use at least one of a plurality of evaluation indices for a system configuration generated by system design to evaluate the system configuration.

According to a fourth example aspect of the present invention, a system design method includes a computer estimating a probability distribution of values of evaluation indices of an embodied system configuration in cases where system configurations that are candidates to be embodied have been embodied in system design involving embodiment of system configurations; calculating expected values of the evaluation indices on the basis of the probability distribution; and selecting one of the system configurations that is a candidate to be embodied on the basis of the expected values of the evaluation indices and embodying the selected system configuration.

According to a fifth example aspect of the present invention, a recording medium is one that records a program for causing a computer to execute estimating a probability distribution of values of evaluation indices of an embodied system configuration in cases where system configurations that are candidates to be embodied have been embodied in system design involving embodiment of system configurations; calculating expected values of the evaluation indices on the basis of the probability distribution; and selecting one of the system configurations that is a candidate to be embodied on the basis of the expected values of the evaluation indices and embodying the selected system configuration.

### Effect of Inventions

According to the present invention, it is expected that the system configuration resulting from the system design will satisfy the specified constraint conditions and also satisfy the constraint conditions at a relatively high level with respect to the performance desired by the user.

### BRIEF DESCRIPTION OF THE DRAWINGS

FIG. 1 is a diagram showing an example of the structure of the design system according to the first example embodiment.

FIG. 2 is a diagram showing an example of a branch of the example embodiment method of the system configuration.

FIG. 3 is a diagram showing an example of the functional configuration of the configuration evaluation portion according to the first example embodiment.

FIG. 4 is a diagram showing an example of a configuration draft that does not satisfy the qualitative condition.

FIG. 5 is a diagram showing an example of a configuration draft that no longer satisfies the qualitative condition due to embodiment.

FIG. 6 is a diagram showing an example of the configuration of the quantitative condition estimation portion according to the first example embodiment.

FIG. 7 is a diagram showing an example of data passing in the quantitative condition estimation portion according to the first example embodiment.

FIG. 8 is a diagram showing an example of the representation of configuration information in a diagram according to the first example embodiment.

FIG. 9 is a diagram showing an example of the textual representation of configuration information according to the first example embodiment.

FIG. 10 is a diagram showing an example of the definition of a component type according to the first example embodiment.

FIG. 11 is a diagram showing an example of the definition of a relationship type according to the first example embodiment.

FIG. 12 is a diagram showing an example of the definition of embodiment rules according to the first example embodiment.

FIG. 13 is a diagram showing an example of a situation concerning the distribution of the probability of observation of the value of s1.conn according to the first example embodiment.

FIG. 14 is a flowchart showing an example of the operation of the system design device according to the first example embodiment.

FIG. 15 is a diagram showing an example of a design screen displayed on a user terminal device by the input/output portion according to the first example embodiment.

FIG. 16 is a diagram showing an example of the configuration of the system design device according to the second example embodiment.

FIG. 17 is a flowchart showing an example of the processing steps in the system design method according to the third example embodiment.

FIG. 18 is a schematic block diagram showing the configuration of a computer according to at least one example embodiment.

### EXAMPLE EMBODIMENT

The following is a description of example embodiments of the present invention, but the following example embodiments do not limit the invention as claimed in the claims set forth below. Not all of the combinations of features described in the example embodiments are essential to the solution of the invention.

### First Example Embodiment

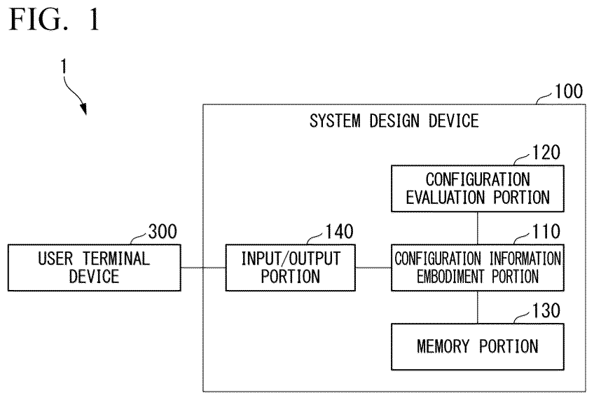

FIG. 1 is a diagram showing an example of the structure of the design system according to the first example embodiment. In the configuration shown in FIG. 1, a design system 1 is provided with a system design device 100 and a user terminal device 300. The system design device 100 is provided with a configuration information embodiment portion 110, a configuration evaluation portion 120, a storage portion 130, and an input/output portion 140. A configuration information embodiment portion 110 is configured to be able to pass data to and from the configuration evaluation portion 120, the storage portion 130, and the input/output portion 140, respectively.

The system design device 100 embodies the system configuration step by step by repeating the process of applying transformation rules for embodiment to the system configuration of the system to be designed, and derives a fully embodied system configuration (i.e., a system configuration that has been embodied to the extent that further embodiment is not required). Conversion rules for embodying system configurations are also referred to as embodiment rules. Embodiment (embodiment process) here means that the system design device 100 makes design decisions, for example, selecting the architecture (single configuration, multiple configurations, etc.) to be used for application deployment and the servers to be used (low-performance servers, high-performance servers, etc.).

For a single system configuration, there can be multiple options for embodiment methods. Therefore, many embodied system configurations can be generated because the embodiment method from a single system configuration repeatedly diverges as the embodiment progresses.

The embodiment method here is a set of embodiment rules applied to a system configuration. Depending on the system configuration and embodiment rules, in general, when applying different embodiment rules to the same system configuration, the resulting system configurations will be different. When multiple embodiment rules are applied to the same system configuration, the system configuration obtained may differ depending on the order in which the embodiment rules are applied.

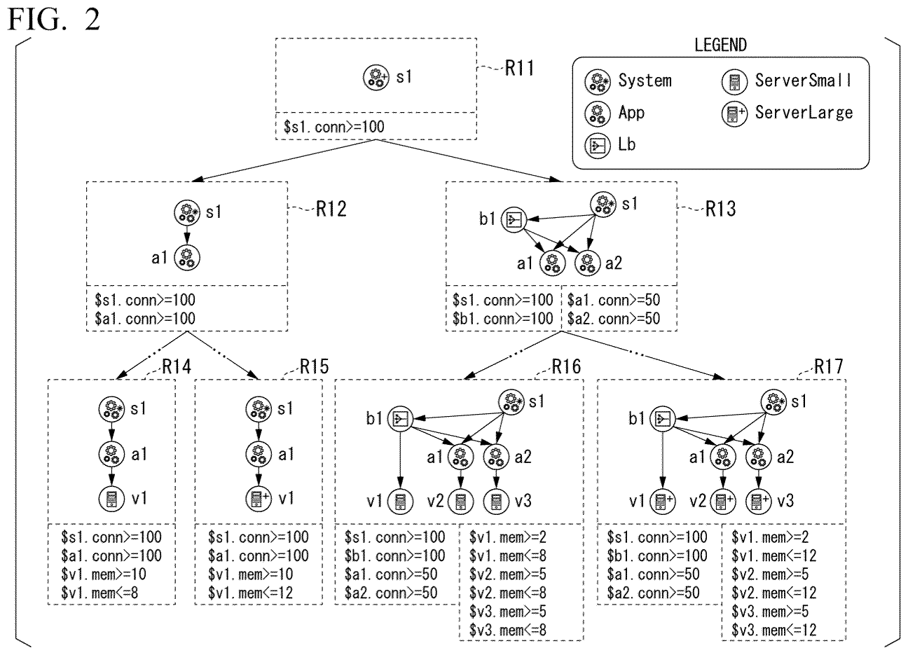

FIG. 2 is a diagram showing an example of a branch of the embodiment method of the system configuration. In FIG. 2, system configurations R11 through R17 are shown. For system configuration R11, each of system configurations R12 through R17 corresponds to an example of an embodied system configuration. For example, from system configuration R11, embodiment to system configuration R12 and to system configuration R13 are possible, with the embodiment methods diverging. By repeating this branching of embodiment, a number of embodied system configurations can be generated.

In the system design device 100, the system configuration is represented in graphical form. Information indicating system configuration is also referred to as configuration information.

The nodes of the graph in the configuration information indicate the various components that make up the system, such as the physical or virtual devices and software modules (applications) used in the system.

Edges between nodes in the graph in the configuration information indicate relationships between components. The edges here may be directed edges or undirected edges. Only some of the edges of the graph representing the system configuration may be directed edges.

Components and edges are also collectively referred to as constituent elements.

Configuration information may further include constraint condition information and priority information.

Constraint condition information is information that indicates the constraint conditions that must be satisfied by the constituent elements. The constraint conditions that a constituent element must satisfy are indicated by equality or inequality equations that indicate the conditions that the evaluation index for that constituent element must satisfy.

Priority information is information indicating the priority of each evaluation index. The priority for each evaluation index is used as a weight value to determine how much importance should be given to the value of each evaluation index when multiple evaluation indices for constituent elements included in a system configuration are shown. In FIG. 2, the priority information is omitted from the figure.

The system configuration expected by the user of the system design device 100 is also referred to as system requirements. The system configuration generated by the system design device 100 is also referred to as a configuration draft. The system configuration output by the system design device 100 as a design result is also referred to as the design result system configuration.

In the example in FIG. 2, system configuration R11 corresponds to an example of a system requirement. System configurations R12 through R17 correspond to examples of configuration drafts. System configurations R12 to R17 are also denoted as configuration drafts R12 to R17.

System requirements and configuration drafts may include indeterminate constituent elements, such as abstract constituent elements or constituent elements on which a constituent element depends and on which some constituent elements are missing. The first constituent element is dependent on the second constituent element, meaning that the relationship is such that the second constituent element is necessary for the first constituent element to function. Examples of such dependencies include the need for an operating system (OS) for the application program to operate and the need for a machine (computer hardware) for the OS to operate. If the system configuration includes the first constituent element and lacks the second constituent element on which the first constituent element depends, the system configuration must be embodied so that the second constituent element is included in the system configuration in order to arrive at a fully embodied system configuration.

On the other hand, the design result system configuration is derived as a fully embodied system configuration and contains no uncertain constituent elements.

A fully embodied system configuration is one that contains no abstract constituent elements and in which all constituent element dependencies are satisfied. As a criterion for determining whether a constituent element is embodied or abstract, for example, whether the constituent element is embodied to the extent that it can be implemented without requiring further embodiment, can be used.

In the example in FIG. 2, each component icon represents a component type. The correspondence between icons and component types is shown in the legend.

The string attached to the component represents the id (identifier, identification information) of each component. The inequalities attached to the graphs also represent constraint conditions. For example, the inequality “$s1.conn>=100” indicates the constraint condition that the value of “conn”, which is an evaluation index associated with the constituent element having the id “s1”, is greater than or equal to 100. Here, “associated” can also be referred to as “linked”.

The specific method of generating the configuration draft is described below.

The system design device 100 acquires the system requirements and applies the embodiment rules to the obtained system requirements to generate a configuration draft. The system design device 100 further applies the embodiment rules to the configuration draft to generate a more embodied configuration draft. The system design device 100 repeats the application of the embodiment rules to the configuration draft until the design result system configuration is obtained or until a determination that the system design has failed.

If the system design is determined to have failed, the system design device 100 goes back to the system requirements or the configuration draft in the middle of the embodiment, and attempts embodiment by a different branch of the embodiment method than the embodiment method that has been used up to that point.

Thus, the system design device 100 uses an exploratory approach to derive an appropriate configuration draft that satisfies the specified conditions among the embodied configuration drafts.

If one can properly evaluate the promise of a configuration draft during the search for a configuration draft, one will be able to select an appropriate embodiment method in the branching of embodiment methods. This reduces the occurrence of rework (redoing) due to design failures and enables the derivation of high-quality configurations. For example, in FIG. 2, if the promise of each of the configuration drafts R12 and R13 can be evaluated, a high-quality design can be efficiently reached by selecting the more promising configuration draft and proceeding with the search in a preferential manner.

In particular, it can reduce the waste of processing time caused by rework when the less promising configuration draft is selected.

The input/output portion 140 functions as either or both an interface with other devices or an interface with the user.

For example, the input/output portion 140 may be equipped with a communication device to receive information on system requirements from the user terminal device 300 and output the received information on system requirements to the configuration information embodiment portion 110. The input/output portion 140 may receive input of the designed specific system configuration information from the configuration information embodiment portion 110 and transmit the input specific system configuration information to the user terminal device 300.

The input/output portion 140 may be provided with input devices, such as a keyboard and mouse, for example, to accept various user operations, such as user operations to enter information on system requirements. The input/output portion 140 may be equipped with a display screen, such as a liquid crystal panel or LED (light emitting diode) panel, for example, to display various images, such as information on the specific system configuration designed.

If the input/output portion 140 functions as an interface with the user, the user terminal device 300 may not be provided.

The following is an example of a case in which the user terminal device 300 functions as an interface with the user (user interface) and the input/output portion 140 communicates with the user terminal device 300.

The user terminal device 300 is equipped with an input device such as a keyboard and mouse, for example, and accepts various user operations, such as user operations to input information on system requirements, and the user terminal device 300 is equipped with a display screen, such as a liquid crystal panel or LED (light emitting diode) panel, to display various images, such as displaying information on the specific system configuration designed.

The user terminal device 300 is an example of a display device.

The configuration information embodiment portion 110 embodies system requirements step by step in multiple steps and generates system configuration information as a result of the embodiment. As described above for the system design device 100, in the embodiment step, the configuration information embodiment portion 110 may generate multiple configuration drafts.

The configuration information embodiment portion 110 is an example of a system configuration embodiment means.

To generate a configuration draft, the configuration information embodiment portion 110 obtains information about the constituent elements and embodiment rules from the storage portion 130.

When there are multiple configuration drafts that are candidates for embodiment, the configuration information embodiment portion 110 passes the configuration information for each configuration draft to the configuration evaluation portion 120 to obtain the evaluation results for each configuration draft. The configuration information embodiment portion 110 selects a configuration draft to be further embodied among multiple configuration drafts based on the obtained evaluation results.

The configuration evaluation portion 120, upon receiving configuration information for a configuration draft from the configuration information embodiment portion 110, evaluates the configuration draft and returns evaluation results.

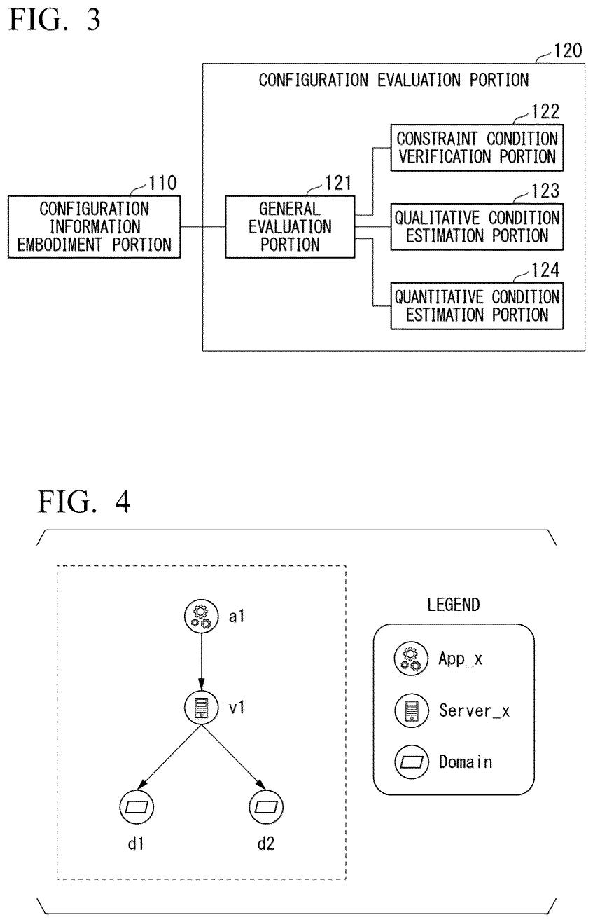

FIG. 3 shows an example of the functional configuration of the configuration evaluation portion 120. In the configuration shown in FIG. 3, the configuration evaluation portion 120 has a general evaluation portion 121, a constraint condition verification portion 122, a qualitative condition estimation portion 123, and a quantitative condition estimation portion 124. The general evaluation portion 121 is configured to pass data to and from the configuration information embodiment portion 110, the constraint condition verification portion 122, the qualitative condition estimation portion 123, and the quantitative condition estimation portion 124, respectively.

The constraint condition verification portion 122, upon obtaining the configuration information of the configuration draft output by the configuration information embodiment portion 110 via the general evaluation portion 121, verifies whether the constraint conditions in the configuration draft are inconsistent or not, and returns the verification results to the general evaluation portion 121.

The configuration draft indicated by the configuration information that the general evaluation portion 121 obtains from the configuration information embodiment portion 110 is also referred to as the configuration draft to be evaluated. The configuration draft to be evaluated can also be considered a configuration that is a candidate to be evaluated.

The constraint condition verification portion 122 is an example of a constraint condition verification means.

In the example in FIG. 2, each configuration draft contains one or more constraint conditions. Of these, the constraint conditions “$v1.mem>=10” and “$v1.mem<=8” included in configuration draft R14 cannot be satisfied simultaneously and are contradictory. Therefore, the constraint condition verification portion 122 determines that the configuration draft R14 does not satisfy the constraint condition. On the other hand, the configuration drafts other than configuration draft R14 do not contain contradictions. Therefore, the constraint condition verification portion 122 determines that configuration drafts other than configuration draft R14 satisfy the constraint condition.

The qualitative condition estimation portion 123, upon acquiring the configuration information of the configuration draft to be evaluated output by the configuration information embodiment portion 110 via the general evaluation portion 121, calculates the fulfillment probability of the qualitative condition in that configuration draft and returns the obtained fulfillment probability to the general evaluation portion 121.

The qualitative condition estimation portion 123 is an example of a qualitative condition estimation means.

The qualitative condition of a configuration draft refers to a qualitative condition that that the configuration draft must satisfy. Specifically, a qualitative condition for a configuration draft is a condition regarding the topology of the graph that represents that configuration draft. The qualitative condition of a configuration draft is also referred to simply as a qualitative condition.

FIG. 4 is a diagram showing an example of a configuration draft that does not satisfy the qualitative condition.

Assume that in the example in FIG. 4, there is a structural constraint that a constituent element of type Server_x cannot be connected to two Domain-type constituent elements. This constraint corresponds to an example of a qualitative condition.

In the configuration draft shown in FIG. 4, a Server_x type constituent element is connected to two Domain-type constituent elements, which does not satisfy the above constraint. Therefore, the configuration draft shown in FIG. 4 is determined not to satisfy the qualitative condition.

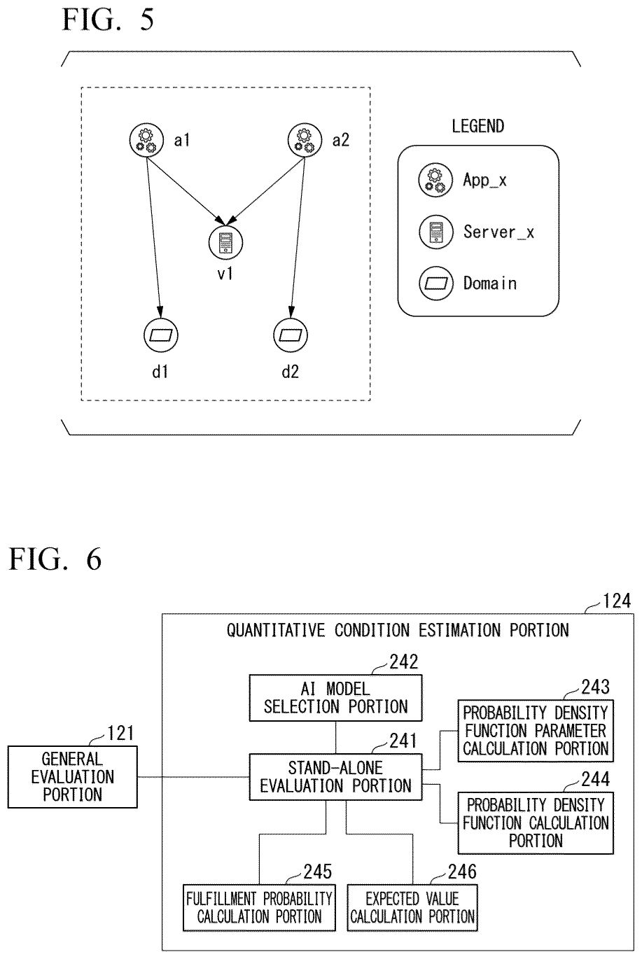

FIG. 5 is a diagram showing an example of a configuration draft that no longer satisfies the qualitative condition due to embodiment.

In the example in FIG. 5, in addition to the constraint in the example in FIG. 4, it is specified that a constituent element of type Server_x to which a constituent element of type App_x connects must connect to the same Domain type constituent element as the one to which the constituent element of the type App_x is connected. This constraint corresponds to an example of a qualitative condition.

The configuration draft shown in FIG. 5 satisfies the qualitative condition at this point.

On the other hand, as the embodiment of this configuration draft proceeds, the constituent element of type Server_x (constituent element with id “v1”) will need to be connected to two constituent elements of type Domain (the constituent element with id “d1” and the constituent element with id “d2”) due to the above constraint. This violates the qualitative condition that a constituent element of type Server_x cannot be connected to two constituent elements of type Domain.

Thus, the configuration draft shown in FIG. 5 cannot satisfy the two qualitative conditions simultaneously as the embodiment proceeds. Thus, the configuration draft shown in FIG. 5 gives rise to a situation where further embodiment is not possible due to contradictions in qualitative conditions that arise as the embodiment progresses.

The probability of fulfillment with respect to qualitative conditions is the probability of going from a configuration draft to be evaluated to a configuration draft that is fully embodied and satisfies the qualitative conditions. The probability of fulfillment with respect to qualitative conditions can be said to be the probability of going from a configuration draft to be evaluated to a fully embodied configuration draft without an incomplete state of embodiment, under the assumption that the fulfillment of constraint conditions related to the evaluation index does not pose a problem.

The probability of fulfillment with respect to qualitative conditions may be defined as, but is not limited to, “the ratio of the number of configuration drafts that are fully embodied and meet the qualitative conditions to the number of configuration drafts that are fully embodied, among the configuration drafts reachable from the configuration draft to be evaluated”. Depending on the definition of the probability of selecting an individual embodiment method in the branch of embodiment methods, various definitions of the probability of fulfillment with respect to qualitative conditions are possible.

The qualitative condition estimation portion 123 estimates the likelihood of obtaining a configuration draft that is fully materialized and satisfies the qualitative conditions when proceeding with embodiment from the configuration draft to be evaluated indicated by the configuration information, and returns the index value indicating the estimation result to the general evaluation portion 121 as the probability of fulfillment with respect to the qualitative conditions.

The qualitative condition estimation portion 123 may use a Graph Neural Network (GNN) to evaluate the configuration information to obtain the probability of fulfillment with respect to the qualitative condition.

This GNN is obtained by machine learning using training data, which is a combination of a configuration draft and a probability value that the embodiment of the configuration draft will not be incomplete. The training data in this case is obtained by repeating the design trials for a large number of configuration drafts and calculating, for each configuration draft, the probability value that the embodiment of that configuration draft will not enter an incomplete state. As a formula for calculating the probability that the embodiment of a configuration draft will not enter an incomplete state, the definition formula for the probability of fulfillment with respect to qualitative conditions can be used.

However, the method by which the qualitative condition estimation portion 123 determines the probability of fulfillment with respect to qualitative conditions is not limited to a specific method. For example, the qualitative condition estimation portion 123 may use a learning model other than GNN to determine the probability of fulfillment with respect to the qualitative condition.

The quantitative condition estimation portion 124, upon acquiring the configuration information of the configuration draft to be evaluated output by the configuration information embodiment portion 110 via the general evaluation portion 121, calculates the fulfillment probability relating to the qualitative condition of that configuration draft and the expected value of the quality and returns the obtained fulfillment probability and expected value to the general evaluation portion 121.

The quantitative condition of a configuration draft is the quantitative condition that the configuration draft must satisfy. Specifically, the quantitative condition of a configuration draft is the condition related to the evaluation indices for the constituent elements included in that configuration draft, and is indicated in the constituent information as the constraint condition that the constituent element must satisfy, as described above. The quantification condition of a constitutive draft is also referred to simply as a quantification condition.

The probability of fulfillment with respect to quantitative conditions is the probability of going from a configuration draft to be evaluated to a configuration draft that is fully embodied and satisfies the quantitative conditions. The fulfillment probability with respect to the quantitative conditions can be said to be the probability that the constraint condition with respect to each evaluation index will be satisfied if the configuration draft to be evaluated results in a fully embodied configuration plan as a result of subsequent embodiment.

The probability of fulfillment with respect to quantitative conditions may be defined as, but is not limited to, “the ratio of the number of configuration drafts that are fully embodied and satisfy the quantitative conditions to the number of configuration drafts that are fully embodied, among the configuration drafts reachable from the configuration draft to be evaluated”. Depending on the definition of the probability of selecting an individual embodiment method in the branch of embodiment methods, various definitions of the probability of fulfillment with respect to quantitative conditions are possible.

The quality of a configuration draft shall be expressed in terms of an evaluation index for the constituent elements included in that configuration draft. The quality of a configuration draft is also referred to simply as quality.

The expected value of quality shall be the expected value at the end of each individual embodiment, i.e., from the configuration draft to be evaluated to the fully embodied configuration draft.

FIG. 6 is a diagram showing an example of the configuration of the quantitative condition estimation portion 124. In the configuration shown in FIG. 6, the quantitative condition estimation portion 124 includes a stand-alone evaluation portion 241, an AI (artificial intelligence) model selection portion 242, a probability density function parameter calculation portion 243, a probability density function calculation portion 244, a fulfillment probability calculation portion 245, and an expected value calculation portion 246. The stand-alone evaluation portion 241 is configured to be able to pass data to and from each of the general evaluation portion 121, the AI model selection portion 242, the probability density function parameter calculation portion 243, the probability density function calculation portion 244, the fulfillment probability calculation portion 245, and the expected value calculation portion 246.

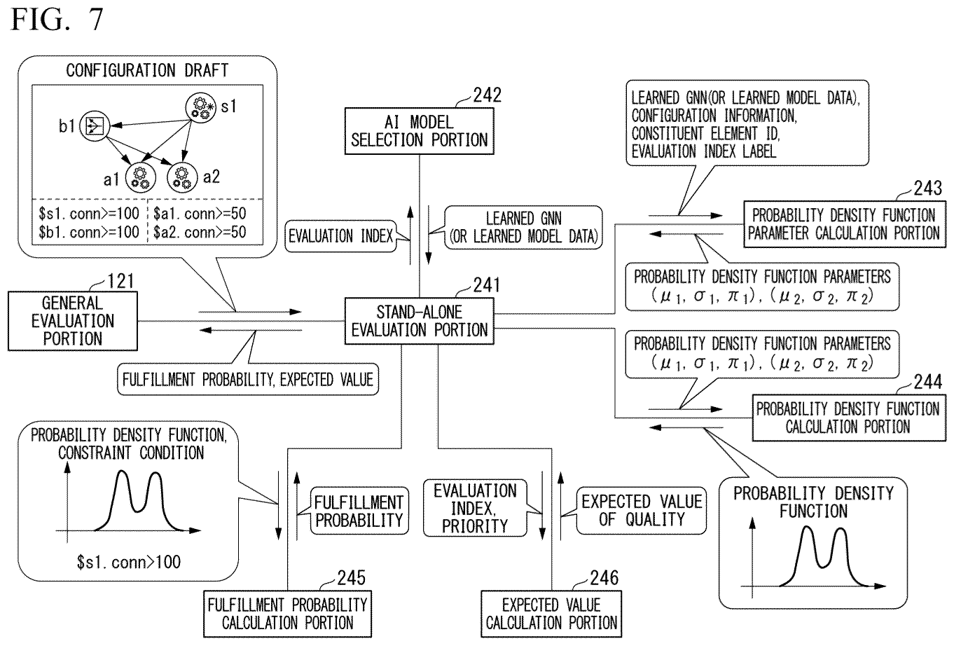

FIG. 7 is a diagram showing an example of data passing in the quantitative condition estimation portion 124.

The quantitative condition estimation portion 124, upon receiving the configuration information of the configuration draft to be evaluated from the general evaluation portion 121 at the stand-alone evaluation portion 241, calculates, in the probability density function calculation portion 244, a probability density function representing the probability distribution for each evaluation index when a fully embodied configuration draft is obtained, for each evaluation index of each constituent element included in that configuration draft (e.g., the maximum number of connections that a constituent element can provide). The stand-alone evaluation portion 241 then calculates the probability of fulfillment and expected value of quality with respect to the quantitative condition based on the obtained probability density function and information on constraint conditions and priorities.

The probability density function calculation portion 244 is an example of a probability distribution estimation means.

Specifically, the stand-alone evaluation portion 241 takes one evaluation index of one constituent element in the configuration draft to be evaluated, passes that evaluation index to the AI model selection portion 242, and receives the learned GNN from the AI model selection portion 242. At that time, the AI model selection portion 242 uniquely determines the learned GNN based on the type of evaluation index and the type of constituent element subject to that evaluation index, and passes it to the stand-alone evaluation portion 241. Passing of a learned GNN can be done, for example, by passing of the GNN's learned model data. In this case, the stand-alone evaluation portion 241 (the receiver of the learned GNN) can set the received model data to the (pre-learned) GNN to obtain a learned GNN.

The stand-alone evaluation portion 241 sends the learned GNN, the configuration information of the configuration draft to be evaluated, the constituent element id and the label of the evaluation index (identification information of the evaluation index) taken from the configuration draft to be evaluated to the probability density function parameter calculation portion 243, and receives the probability density function parameter value from the probability density function parameter calculation portion 243.

Here, the probability density function parameter is information that includes one or more sets of three pieces of information: mean μ, variance σ, and mixing coefficient π. The set of parameters of mean μ, variance σ and mixing coefficient π represents one normal distribution (Gaussian distribution). In particular, from a set of mean μ and variance σ information, it is possible to recover a probability density function that forms a single normal distribution. The mixing coefficient π is a parameter that represents the weight of each probability density function when there are multiple probability density functions.

For example, in generating a single probability density function by synthesizing each probability density function consisting of two sets of parameters, when the mixing coefficient for the first set is π1 and that for the second set is π2, synthesis should be performed after adjusting the values so that the ratio of the areas of each probability density function becomes π1 to π2. To synthesize two probability density functions, simply add the values together and then normalize them so that the probabilities sum to 1.

The aforementioned learned GNN can be acquired by providing the learning data of the set of the configuration draft, evaluation index, and probability density function parameter to the GNN before the start (prior to the start of design by the system design device 100) and then conducting machine learning. The training data for the set of values of the configuration draft, evaluation index, and probability density function parameter required for training can be generated by repeating the design trials for a large number of configuration drafts in advance, collecting samples of the values obtained by observing the values of the evaluation index in the design results, and performing calculations to estimate the likelihood (calculations to estimate the probability density distribution of the evaluation index values).

However, the method by which the probability density function parameter calculation portion 243 obtains the parameters of the probability density function is not limited to a specific method. For example, the probability density function parameter calculation portion 243 may use a learned training model other than the GNN to obtain the parameters of the probability density function.

The stand-alone evaluation portion 241 passes the probability density function parameters to the probability density function calculation portion 244 and receives the probability density function from the probability density function calculation portion 244. The probability density function calculation portion 244 restores the probability density function by restoring the normal distribution from the received probability density function parameters and synthesizing the function after adjusting the value of each normal distribution, using the mixture coefficient as a weight coefficient.

The stand-alone evaluation portion 241 passes the probability density function and constraint condition to the fulfillment probability calculation portion 245 and receives the fulfillment probability from the fulfillment probability calculation portion 245. The fulfillment probability calculation portion 245 calculates the probability of obtaining a value in the range indicated by the constraint condition (a value that satisfies the constraint condition) in the probability density function. Specifically, the fulfillment probability calculation portion 245 calculates the integral value (area) of the probability density for the range indicated by the constraint condition, and considers this the fulfillment probability.

The fulfillment probability calculation portion 245 is an example of a fulfillment probability calculation means.

For all evaluation indices to which priority is assigned, the stand-alone evaluation portion 241 passes all those evaluation indices and priority pairs to the expected value calculation portion 246 to receive the expected value of quality. The expected value calculation portion 246 calculates the expected value from the probability density function for each evaluation index, multiplies it by the priority, sums these values for all evaluation indices, and has this sum serve as the expected value of the quality of the configuration draft to be evaluated.

The expected value calculation portion 246 is an example of an expected value calculation means.

Here, for example, evaluation indices related to network bandwidth and those related to cost have different value ranges that can be taken, and also have different objectives for optimization of evaluation index values, such as whether they should be maximized or minimized. Such differences in the value range or purpose of the evaluation index may make it meaningless to simply add together the expected value multiplied by the priority.

Therefore, in calculating the expected value from the probability density function, the expected value calculation portion 246 may add a predetermined post-processing to the expected value for each type of evaluation index in order to align the value range and objective of the expected value obtained from each evaluation index. For example, the expected value calculation portion 246 may perform normalization on the expected value so that the value range of the expected value is aligned with the range of 0 to 1. The expected value calculation portion 246 may also subtract the normalized expected value from 1 for the evaluation index to be minimized in order to align the objective of the expected value.

The general evaluation portion 121 receives the results of the verification of the consistency of the constraint conditions from the constraint condition verification portion 122 for the configuration draft to be evaluated. The general evaluation portion 121 receives the probability of fulfillment regarding qualitative conditions from the qualitative condition estimation portion 123 for the configuration draft to be evaluated. The general evaluation portion 121 receives, from the quantitative condition estimation portion 124, the fulfillment probabilities for quantitative conditions, of each constituent element and each evaluation index, as well as the expected value of quality of the configuration draft.

The general evaluation portion 121, upon obtaining a verification result from the constraint condition verification portion 122 that the constraint conditions are inconsistent, may reject the configuration draft to be evaluated, and omit the estimation of the fulfillment probability regarding the qualitative conditions by the qualitative condition estimation portion 123 and the estimation of the fulfillment probability regarding the quantitative conditions and the calculation of the expected value of quality by the quantitative condition estimation portion 124.

The general evaluation portion 121 adopts the minimum value of the fulfillment probability regarding the qualitative condition and the fulfillment probability regarding the quantitative condition for each constituent element and each evaluation index as the fulfillment probability of the configuration draft. A11 of these fulfillment probabilities are probabilities of fulfillment with respect to conditions that must be satisfied. Therefore, the general evaluation portion 121 focuses on the smallest value among these fulfillment probabilities and evaluates the configuration drafts with the highest possible value as promising configuration drafts.

The general evaluation portion 121 may calculate a single evaluation value for each configuration draft by weighting and summing the adopted fulfillment probabilities and expectations using separately determined weight values.

There is a trade-off between the time required to derive a configuration plan and the quality of the derived configuration plan, and the weight values described above represent which of the two is more important. Relatively large weight values for the probability of fulfillment increase the probability of obtaining a configuration plan, while the quality obtained tends to be lower. Conversely, a relatively large weight value for the expected value will make it easier to obtain high-quality configurations, while making it more difficult to derive a configuration plan. The aforementioned weight values can be pre-set to specific values or may be specified by the user through the input/output portion 140.

The components and relationships described above are collectively denoted as constituent elements. The constituent element may be assigned an id and a type name indicating the type of the constituent element. In addition, constituent elements may be assigned attribute values. In addition to the nodes and edges, the configuration information may also be assigned constraint conditions that the nodes and edges must satisfy and the priority of the evaluation index.

There are two ways of expressing configuration information: by diagram and by text.

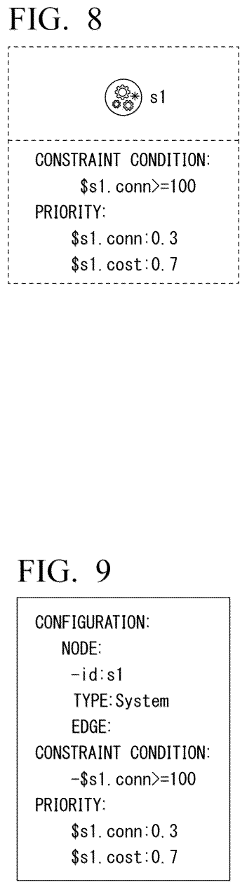

FIG. 8 shows an example of a graphical representation of configuration information. In the example in FIG. 7, circles indicate nodes. Also, as in the example in FIG. 2, the arrows connecting the circles indicate edges. In the diagrammatic representation of the configuration information, the type names of the components are omitted and represented by the different icon designs. An example of the correspondence between the icon design and the type name is shown in the legend of FIG. 2.

The diagrammatic representation of the configuration information may omit the type name of the relationship. A diagrammatic representation of the configuration information may be used to indicate the id of the components with a circle. The display of the id of this component may be omitted.

In a diagrammatic representation of configuration information, constraint conditions may be listed as expressions under the configuration information. In the example in FIG. 8, an id prefixed with a dollar sign “$” indicates that it refers to an id defined elsewhere.

FIG. 9 shows an example of a textual representation of configuration information. FIG. 9 shows an example of a textual representation of the same configuration information as in FIG. 8.

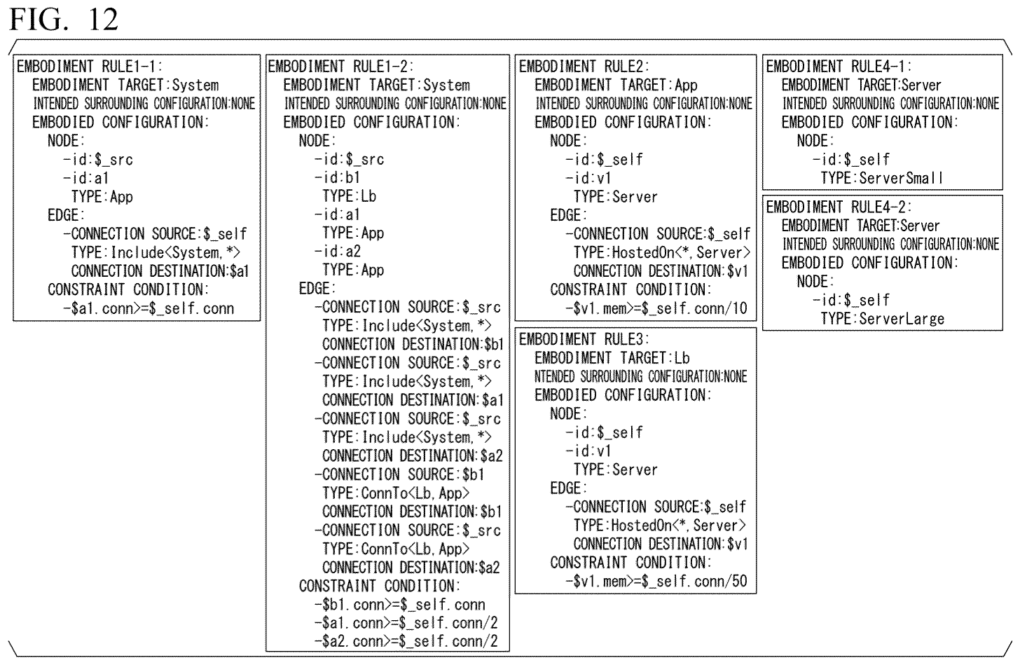

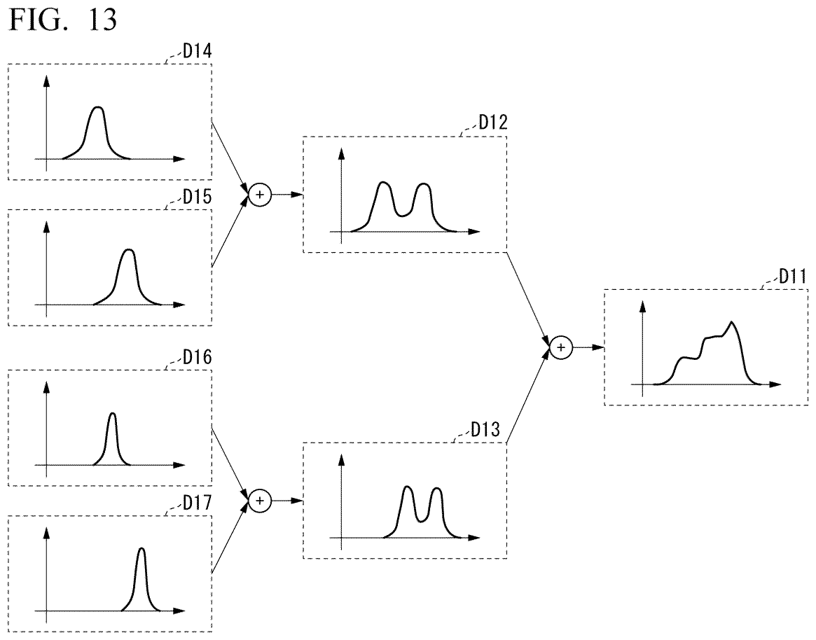

In the first example embodiment, the case in which configuration information is expressed in YAML format as a textual representation of configuration information is described as an example. Specifically, the configuration information includes a list of nodes, a list of edges, and a list of constraint conditions. Each node is defined with an id and type. Each edge is defined with the id of the node from which it is connected, the type of relationship, and the id of the node to which it is connected. The description of the edges is illustrated within the post-embodiment configuration contained in each of the embodiment rules listed in FIG. 12.

The two comma-separated elements in the parentheses “< >” after the type name of the relationship, illustrated in FIG. 12, are the type name of the node, and specify the type of the node specified for the source and destination of the relationship, respectively. The part that does not specify the node type is indicated by an asterisk “*”. Constraint conditions include a list of conditions regarding the value of the evaluation index for each constituent element as an expression. Priority specifies the priority value for each evaluation index.

However, the method of textual representation of configuration information is not limited to any particular method.

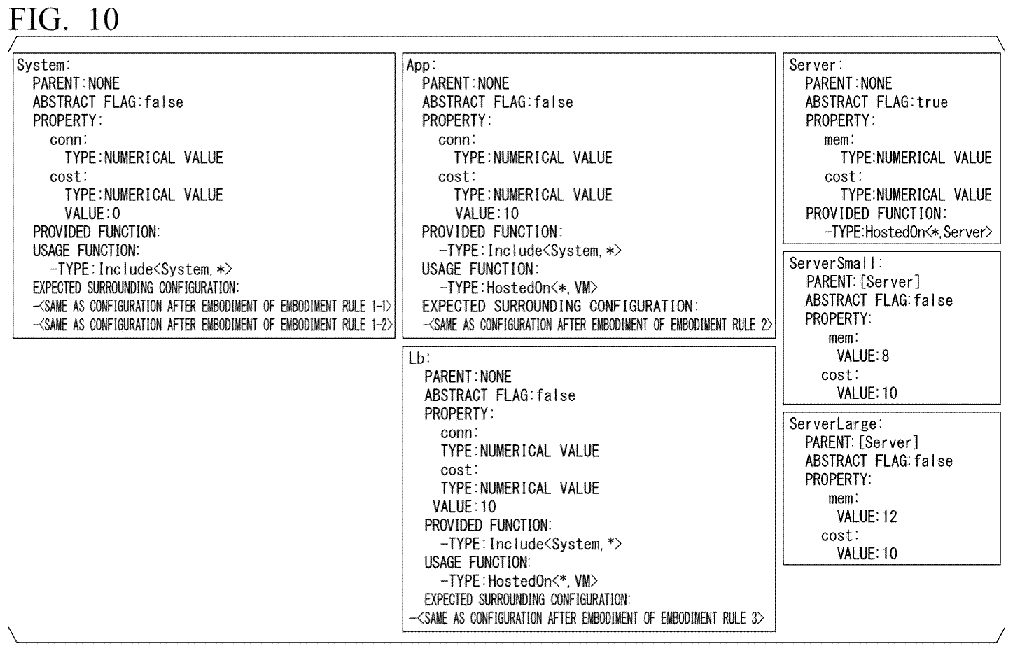

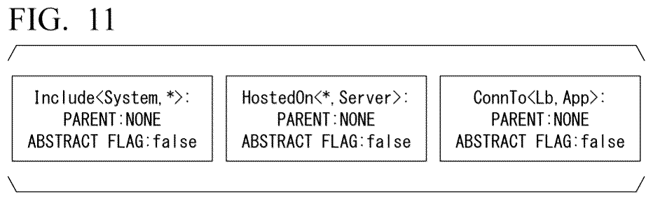

FIG. 10 shows an example of a component type definition. FIG. 8 shows an example of six type definitions: “System”, “App”, “Lb”, “Server”, “ServerSmall”, and “ServerLarge”.

The type definition of each component may specify the parent, abstract flag, property, provided function, used function, and expected surrounding configuration, or any combination thereof.

Parent specifies the type name of other components from which the component type is inherited. System, App, Lb, and Server are the base classes and therefore inherit nothing. In contrast, ServerSmall and ServerLarge inherit Server. Types that inherit from other types inherit information about properties, provided functions and used functions, and expected surrounding configurations from the parent. For types that inherit from other types, the display of information inherited from the parent is omitted.

The abstract flag is a flag indicating whether or not a component of the type is an abstract component. The components of the Server type are abstract, while the components of the other five types are concrete.

The property defines the attribute values that the component of that type has. Each attribute value defines a value type.

The provided function defines the relationships to which components of that type are assumed to be connected from other components.

The usage function defines the relationships that are intended to connect from components of that type to other components.

The expected surrounding configuration indicates the configuration of the surroundings of the component of that type that must be satisfied for the component to operate. For example, in order for an App-type component to operate, a Server-type component is required, and the App-type component must be connected to the Server-type component in a HostedOn relationship. In the expected surrounding configuration of the App type, the surrounding configuration that represents the relevant situation is defined. In FIG. 10, the expected surrounding configurations are shown with references in FIG. 12, while specific descriptions are omitted in FIG. 10.

Multiple expected surrounding configurations may be specified. If multiple expected surrounding configurations are specified, it is interpreted that one of the surrounding configurations should be satisfied.

FIG. 11 shows an example of a relationship type definition. FIG. 11 shows examples of definitions of three relationship types: “Include<System, *>”, “HostedOn<*, Server>”, and “ConnTo<Lb, App>”.

In the definition of each relationship type, the parent, the abstract flag, and the expected surrounding configuration can be specified. Include<System, *> is a relation type that represents a relationship in which a component of type System encompasses some component. HostedOn<*, Server> is a relationship type that represents a relationship in which some component is hosted by a component of type Server. ConnTo<Lb, App> is a relationship type that represents a relationship in which a component of type Lb is communicatively connected to a component of type App.

The parent specifies the type name of the other relationship that the relationship of that type inherits.

The abstract flag is a flag indicating whether the relationship of that type is an abstract relationship or not.

The expected surrounding configuration indicates the surrounding configuration of the relationship that must be satisfied for the relationship of that type to operate.

FIG. 12 shows an example of an embodiment rule definition. FIG. 12 shows examples of definitions of six types of embodiment rules: Embodiment Rule 1-1, Embodiment Rule 1-2, Embodiment Rule 2, Embodiment Rule 3, Embodiment Rule 4-1, and Embodiment Rule 4-2.

As described above, embodiment rules are conversion rules for rewriting the system configuration. In other words, embodiment rules are information indicating how to embody configuration information.

In the definition of each embodiment rule, the object to be embodied, the assumed surrounding configuration, and the configuration after embodiment can be specified.

The type name of the constituent element to be embodied is specified for the object to be embodied. In the example in FIG. 12, each embodiment rule targets only one constituent element for embodiment, and only one constituent element is embodied in a single step of embodiment.

The assumed surrounding configuration specifies the surrounding configuration that must be satisfied a priori in applying the embodiment rule. In other words, the embodiment rule can be applied only when the configuration indicated in the assumed surrounding configuration is recognized around the constituent element to be embodied.

The post-embodiment configuration specifies the configuration that remains after the application of the embodiment rule. When the embodiment rule is applied, the constituent element to be embodied is replaced by the configuration shown in the post-embodiment configuration.

For example, Embodiment Rule 2 is a rule that allows Server-type components to host App-type components. The “$_self” in the post-embodiment configuration indicates the constituent element to be embodied, so that the constituent element to be embodied is preserved after embodiment. In addition, in Embodiment Rule 2, a new Server type node (component) is prepared, and the node indicated by $_self is connected to the above Server type node by a HostedOn type relationship. Furthermore, in Embodiment Rule 2, a constraint condition is added to the added Server type node (v1). Here, the condition is specified that the value of $v1.mem, a property indicating the amount of memory provided by v1, must be at least one-tenth the value of $_self.conn, a property indicating the maxConnection of App. This condition is expressed as a constraint condition with $v1.mem as the evaluation index in the configuration draft after embodiment by Embodiment Rule 2.

Embodiment Rule 4-1 is also a rule that replaces the abstract Server type constituent element with a concrete ServerSmall type constituent element.

FIG. 2 shows an example of how the system requirements described in FIG. 6 are embodied step by step based on the definitions and rules shown in FIGS. 10, 11 and 12. For example, configuration draft R12 is generated by applying the Embodiment Rule 1-1 described in FIG. 12 to the s1 node in the system configuration R11 in FIG. 2. By further applying Embodiment Rule 4-1 or 4-2 to the abstract Server type node generated by applying Embodiment Rule 2 described in FIG. 12 to node al of configuration draft R12, configuration draft R14 or configuration draft R 15 is generated.

Each constituent element is determined to be embodied if two things are satisfied: the abstract flag of the type is true and the expected surrounding configuration is satisfied. A configuration draft is determined to be embodied if all the constituent elements it encompasses are embodied.

The set of configuration drafts on the tree thus obtained is called the configuration draft tree. A huge number of configuration drafts can be generated from a single system requirement. In contrast, a system configuration can be derived efficiently by avoiding the actual generation of all possible configuration drafts that can be generated and focusing on promising configuration drafts that satisfy the conditions. At this point, the constraint condition formula alone is not necessarily sufficient to sufficiently refine the configuration draft. For example, in FIG. 2, the only configuration with conflicting constraint conditions is configuration draft R14, while the other configuration drafts R15, R16, and R17 can all satisfy the constraint conditions.

On the other hand, differences in performance can occur even among configurations that satisfy the constraint conditions.

FIG. 13 shows an example of the situation regarding the distribution of the probability of observation of the value of s1.conn. s1.conn is an evaluation index of the system's performance.

Graphs D11 to D17 of the probability distribution shown in FIG. 13 show the distribution of observation probabilities of expected s1.conn values in the system configurations R11 to R17 shown in FIG. 2. Here, the configuration drafts R14 and R15 are both single-component, whereas the configuration drafts R16 and R17 are both multiple-component. In this respect, graphs D16 and D17 of the probability distribution will have probabilities distributed at higher performance values than graphs D14 and D15 of the probability distribution.

In addition, configuration drafts R14 and R16 use low-performance servers, whereas configuration drafts R15 and R17 use high-performance servers. In this respect, graphs D15 and D17 of the probability distribution will have probabilities distributed at higher performance values than graphs D14 and D16 of the probability distribution.

The configuration draft R12 is a configuration draft in the process of deriving the configuration draft R14 or configuration draft R15. Therefore, graph D12 of the probability distribution is a graph of the distribution that is a composite of graphs D14 and D15 of the probability distribution. Similarly, the configuration draft R13 is a configuration draft in the process of deriving the configuration draft R16 or R17. Therefore, graph D13 of the probability distribution is a graph of the distribution that is a composite of graphs D16 and D17 of the probability distribution.

In this case, the system configuration with the highest performance is the system configuration in configuration draft R17, so it is desirable to be directed to configuration draft R17 in the configuration draft tree search, at least when performance is the only requirement. If the GNN can correctly estimate the actual situation, the probability distribution shown in FIG. 13 can be generated during the search.

The system design device 100 can determine that the configuration draft R13 is more promising by calculating the area of the s1.conn>=100 range for the probability distributions shown in graphs D12 and D13, respectively, to calculate the fulfillment probability. Similarly, the system design device 100 can determine that the configuration draft R17 is more promising by calculating the area of the s1.conn>=100 range for the probability distributions shown in graphs D16 and D17, respectively, to calculate the fulfillment probability.

On the other hand, it is not necessarily desirable to be guided to the configuration draft R17 if performance is only required to meet the constraints, and if the optimal design considering both performance and price within that range is to be considered. For example, if price is a high priority, it may be desirable to be directed to the configuration draft R15 with fewer constituent elements or the configuration draft R16 with lower server performance.

If the GNN can correctly estimate the situation for each valuation index, a probability distribution for price can be generated during the search, similar to the probability distribution for performance illustrated in FIG. 13. For each probability distribution, the system design device 100 can calculate the expected value of s1.conn, the performance evaluation index, and s1.cost, the price evaluation index, and multiply each by its weight and add them together to calculate the evaluation score for each configuration draft. This allows the system design device 100 to determine that a configuration draft with a higher evaluation score is more promising.

This evaluation score for each configuration draft is also referred to as the optimization score. Optimization here is optimization of the system design, i.e., optimization to ensure that the design result system requirements match the user's wishes as closely as possible. This optimization may be an optimization of the value of the evaluation index specified by the user. For example, this optimization may be to make the value of the evaluation index specified by the user as large as possible or as small as possible, depending on the priority level specified by the user.

The operation of the system design device 100 shall be described next.

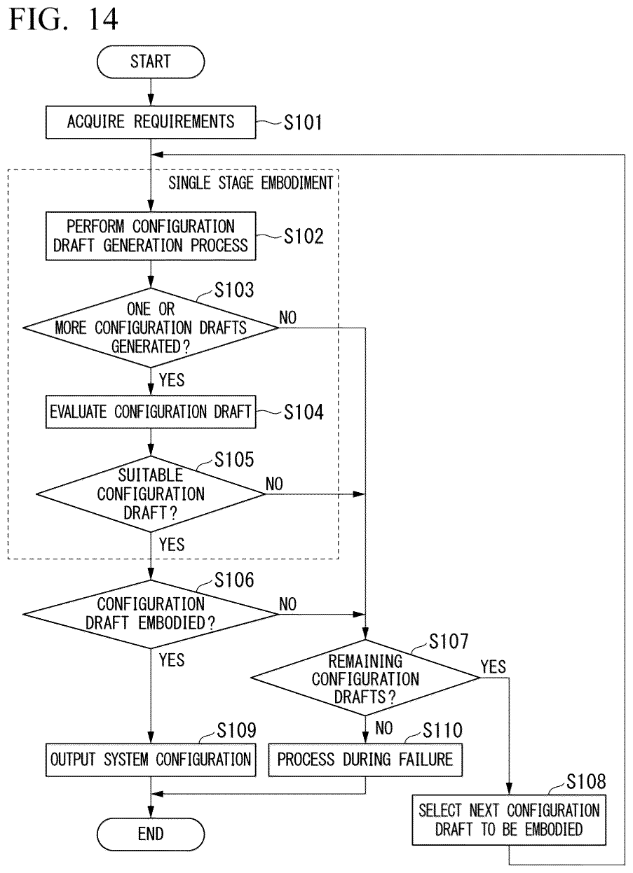

FIG. 14 is a flowchart showing an example of operation of the system design device 100. First, a general overview of the operation shall be given.

First, the configuration information embodiment portion 110 accepts input of system requirements from the user terminal device 300 via the input/output portion 140 (Step S101). The configuration information embodiment portion 110 then embodies the system requirements step by step (steps S102 to S108) and outputs the fully embodied system configuration to the user terminal device 300 via the input/output portion 140 (Step S109).

The configuration information embodiment portion 110 first performs one stage of embodiment (S102 to S106) as a stepwise embodiment, and determines whether or not an embodied configuration draft is included among the multiple configuration drafts obtained (S106).

The configuration information embodiment portion 110 determines that a configuration draft is embodied if all constituent elements encompassed by the configuration draft are embodied. The configuration information embodiment portion 110 determines that a constituent element is embodied if two conditions are satisfied: the abstract flag of the type of the constituent element is true, and the expected surrounding configuration in the constituent element is satisfied. Information on the constituent element types necessary to determine whether a configuration draft is embodied is stored in the storage portion 130, and the configuration information embodiment portion 110 reads this information from storage portion 130.

If it is determined that an embodied configuration draft is included (Step S106: YES), the configuration information embodiment portion 110 outputs that embodied configuration draft as the design result system configuration (Step S109).

After Step S109, the system design device 100 terminates the process shown in FIG. 14.

On the other hand, if it is determined in Step S106 that no embodied configuration draft is included (Step S106: NO), the configuration information embodiment portion 110 determines whether there are still other abstract configuration drafts in the configuration draft tree (Step S107). Specifically, the configuration information embodiment portion 110 determines whether there is a configuration draft that has already been generated, has not been rejected, and to which the embodiment rules can be applied.

If it is determined that abstract configuration drafts remain (Step S107: YES), the configuration information embodiment portion 110 selects one of the remaining abstract configuration drafts to be embodied next (Step S108) and performs the one-stage embodiment again. That is, after Step S108, the process returns to Step S102.

On the other hand, if the configuration information embodiment portion 110 determines that no abstract configuration draft remains (Step S107: NO), further design study is not possible, and the system design device 100 performs the process predetermined as the process during design failure (Step S110).

After Step S110, the system design device 100 terminates the process shown in FIG. 14.

In the one-stage embodiment, the configuration information embodiment portion 110 performs a process to generate a configuration draft by applying applicable embodiment rules to the system requirements input in Step S101 or the configuration draft selected in Step S108 as the next configuration draft to be embodied (Step S102). If there is more than one applicable embodiment rule, the configuration information embodiment portion 110 generates multiple configuration drafts. On the other hand, if there is no single applicable embodiment rule, the configuration information embodiment portion 110 does not generate a configuration draft. In other words, the configuration information embodiment portion 110 fails to generate a configuration draft.

Information on the constituent element types necessary to generate a configuration draft (e.g., the information shown in FIGS. 10 and 11) and information on the embodiment rules (e.g., the information in FIG. 12) are stored in the storage portion 130. The configuration information embodiment portion 110 reads this information from the storage portion 130. The configuration information embodiment portion 110 then determines whether one or more configuration drafts have actually been generated (Step S103).

If it is determined that no configuration draft was generated (Step S103: NO), the configuration information embodiment portion 110 proceeds to the embodiment of other configuration drafts on the configuration draft tree, because one-stage embodiment is a failure. Specifically, in the case of Step S103: NO, the process proceeds to Step S107.

On the other hand, if it is determined in Step S103 that one or more configuration drafts have been generated (S103: YES), the configuration information embodiment portion 110 passes each generated configuration draft to the configuration evaluation portion 120 to receive an evaluation result (Step S104).

The configuration information embodiment portion 110 selects the next configuration draft to be embodied in Step S108 based on the evaluation result assigned to each configuration draft in Step S104.

When the configuration evaluation portion 120 receives the configuration draft to be evaluated from the configuration information embodiment portion 110 in the process of Step S104, the general evaluation portion 121 passes the configuration draft to be evaluated to the constraint condition verification portion 122 and receives a verification result from the constraint condition verification portion 122.

The general evaluation portion 121 refers to the received verification result to determine whether there is any inconsistency in the constraint conditions of the configuration draft to be evaluated. If it is determined that there is an inconsistency in the constraint conditions, the general evaluation portion 121 returns the determination result that the configuration draft to be evaluated should be rejected to the configuration information embodiment portion 110.

On the other hand, if it is determined that there is no contradiction in the constraint conditions, the general evaluation portion 121 passes the configuration draft to the qualitative condition estimation portion 123 and receives the fulfillment probability regarding the qualitative conditions from the qualitative condition estimation portion 123. The general evaluation portion 121 determines whether the fulfillment probability with respect to the received qualitative conditions is greater than or equal to a predetermined threshold value.

If the fulfillment probability with respect to the qualitative conditions is determined to be less than the threshold value, the general evaluation portion 121 retums the determination result that the configuration draft to be evaluated should be rejected to the configuration information embodiment portion 110.

On the other hand, if it is determined that the fulfillment probability regarding the qualitative condition is greater than the threshold value, the general evaluation portion 121 passes the configuration draft to the quantitative condition estimation portion 124 and receives the fulfillment probability regarding the quantitative condition and the expected value of quality from the quantitative condition estimation portion 124.

The general evaluation portion 121 takes the minimum value from the fulfillment probability about the qualitative conditions and the fulfillment probability about the multiple quantitative conditions, and uses this value as the fulfillment probability of the configuration draft to be evaluated. The general evaluation portion 121 performs a weighted sum of the fulfillment probability and expected value of the configuration draft to be evaluated, and returns the obtained value to the configuration information embodiment portion 110 as the evaluation value of the configuration draft to be evaluated.

When the quantitative condition estimation portion 124 receives the configuration draft to be evaluated from the general evaluation portion 121, the stand-alone evaluation portion 241 extracts the respective evaluation indices for the respective constituent elements in the configuration draft. The quantitative condition estimation portion 124 performs selection of an AI model by the AI model selection portion 242, calculation of probability density function parameters by the probability density function parameter calculation portion 243, calculation of the probability density function by the probability density function calculation portion 244, and calculation of fulfillment probability related to quantitative conditions by the fulfillment probability calculation portion 245 for each evaluation index. Furthermore, the stand-alone evaluation portion 241 passes all pairs of evaluation indices to which priority has been assigned and the priority to the expected value calculation portion 246, which calculates the expected value of quality. The stand-alone evaluation portion 241 returns the obtained fulfillment probability for multiple quantitative conditions and the expected value of one quality to the general evaluation portion 121.

Next, an example of a GUI (Graphical User Interface) screen displayed by the input/output portion 140 on the user terminal device 300 is described. The input/output portion 140 may be equipped with a display screen to display the GUI screen.

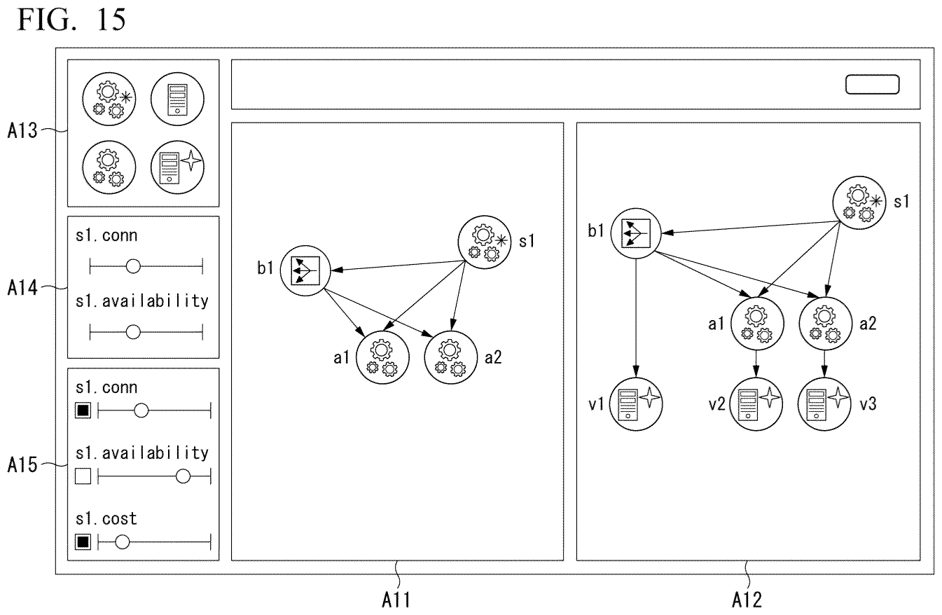

FIG. 15 shows an example of a design screen displayed by the input/output portion 140 on the user terminal device 300. In the example in FIG. 15, an area A11 is the area for users to edit system requirements. The area A11 is also referred to as the requirements editing pane.

An area A12 is the area where the design result system configuration is displayed. The area A12 is also referred to as the design result confirmation pane. An area A13 is an area where a list of components that can be selected by the user is displayed. The area A13 is also referred to as the list display area of selectable parts.

An area A14 is an area where a list of evaluation indices for which users can set constraint conditions (quantitative conditions) and a bar for setting the values of the constraint conditions for those evaluation indices are displayed. The bar displayed in the area A14 is also referred to as the quantitative condition adjustment bar. The area A14 is also referred to as the display area of the quantitative condition adjustment bar.

An area A15 displays a list of evaluation indices that the user can specify as targets for optimization, a check box to select whether or not to make a target of optimization for each evaluation index, and a bar to adjust the optimization priority. The bar displayed in the area A15 is also referred to as the priority adjustment bar. The area A15 is also referred to as the display area for selection options of the index to be optimized and the priority adjustment bars.

However, the method by which user terminal device 300 accepts input for optimization priority is not limited to the method by displaying a bar. For example, the user terminal device 300 may display a button for accepting a user operation to increase the optimization priority and a button for accepting a user operation to decrease the optimization priority in the area A15, allowing user operations to increase or decrease the priority of optimization.

The area A15 corresponds to an example of a user operation area. The user terminal device 300 is an example of a display device. The optimization priority corresponds to an example of a weight value set for each evaluation index. The input/output portion 140 that obtains the optimization priority from the user terminal device 300 is an example of an input/output means.

The check box displayed in area A15 corresponds to an example of an icon for accepting a user operation to indicate whether or not to use the evaluation index for evaluating the system configuration.

The user edits the system requirements by selecting the desired component from the parts listed in the area A13 and operating the adjustment bars and check boxes listed in areas A14 and A15. Thus, the design screen shown in FIG. 15 allows the user to edit the system requirements while selecting the desired conditions to be considered in the system requirements.

As described above, the probability density function calculation portion 244 estimates a probability distribution of values of evaluation indices of an embodied system configuration in cases where system configurations that are candidates to be embodied have been embodied in the system design involving embodiment of system configurations. The expected value calculation portion 246 calculates the expected value of the evaluation indices on the basis of the probability distribution of the values of the evaluation indices. The configuration information embodiment portion 110 selects one of the system configurations that is a candidate to be embodied on the basis of the expected values of the evaluation indices, and embodies the selected system configuration.

Thus, it is expected that the configuration information embodiment portion 110, by selecting the system configuration to be embodied based on the expected value of the evaluation index, selects the system configuration to have a high value of the evaluation index for the performance desired by the user. According to the system design device 100, it is expected that the system configuration will be obtained that satisfies the specified constraint conditions in this regard, as well as satisfies the constraint conditions at a relatively high level with respect to the user's desired performance.

The expected value calculation portion 246 also calculates the expected value for each of the multiple evaluation indices for a single system configuration. The configuration information embodiment portion 110 weights and sums the expected values for each of the multiple evaluation indices using the weight values set for each evaluation index, and selects one of the candidate system configurations that are candidates to be embodied based on the total value obtained.

According to the system design device 100, system design can be performed by considering multiple evaluation indices.

The input/output portion 140 also accepts weight value settings by the user of the system design device 100.

According to the system design device 100, the user's wishes are expected to be more accurately reflected in the system design in that the system design is performed according to the weight values set by the user for each of the multiple evaluation indices.

The fulfillment probability calculation portion 245 calculates the probability that the constraint condition set in relation to the evaluation index is satisfied based on the probability distribution of the values of the evaluation index for the embodied system configuration. The configuration information embodiment portion 110 selects one of the system configurations that are candidates to be embodied based on the expected value of the evaluation index and the probability that the constraint condition holds true.

According to the system design device 100, it is possible to satisfy both the specified constraint conditions and the relatively high performance desired by the user.

The qualitative condition estimation portion 123 estimates the probability that the qualitative condition relating to the embodied system configuration will be satisfied when the system configuration that is a candidate to be embodied is embodied. The configuration information embodiment portion 110 selects one of the system configurations that are candidates to be embodied based on the expected value of the evaluation index, the probability that the constraint condition holds true, and the minimum value among the probabilities that the qualitative condition holds true.

According to the system design device 100, it is expected to be able to select a system configuration that is relatively easy to succeed in system design by selecting a system configuration that is a candidate for embodiment based on the probability that a condition that is considered highly likely to hinder successful system design will hold true being the smallest value. According to the system design device 100, it is expected that system design can be performed efficiently in this respect.

In addition, the constraint condition verification portion 122 determines whether there is any inconsistency in the constraint conditions set for each evaluation index for the system configuration that is a candidate for embodiment. The probability density function calculation portion 244 suppresses the estimation of the probability distribution if it is determined that the constraint conditions are inconsistent.

According to the system design device 100, it is expected that the processing load can be reduced in terms of suppressing the estimation of probability distributions, and that the time required for system design can be relatively short.

The user terminal device 300 also displays a user operation area for accepting input of a weight value for each of a plurality of evaluation indices for the system configuration generated by the system design.

The system design device 100 is expected to obtain a system configuration that more appropriately reflects the user's wishes by designing the system based on the weighting set by the user.

The user terminal device 300 also displays an icon for accepting a user operation indicating whether or not to use at least one of the multiple evaluation indices for the system configuration generated by the system design in the evaluation of the system configuration.

Users can specify evaluation indices to be used in the evaluation of the system configuration by an operation on the display screen, and in this respect, it is relatively easy to specify evaluation indices to be used in the evaluation of the system configuration. By designing the system according to the user's specifications, the system design device 100 is expected to obtain a system configuration that more appropriately reflects the user's wishes.

### Second Example Embodiment

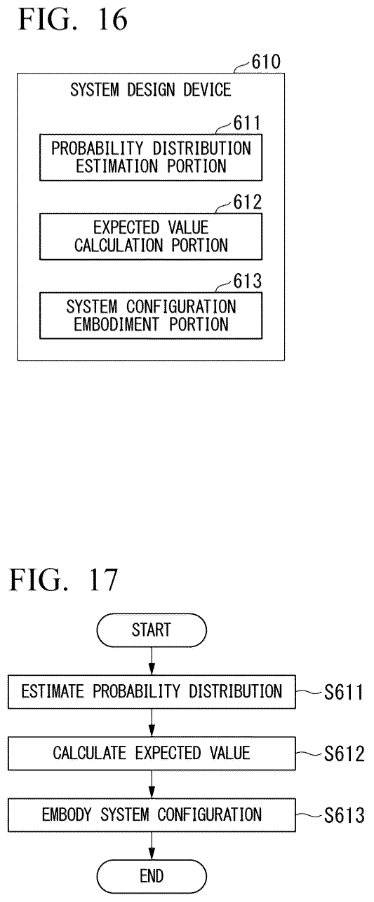

FIG. 16 is a diagram showing an example of the configuration of the system design device according to the second example embodiment. In the configuration shown in FIG. 16, the system design device 610 is provided with a probability distribution estimation portion 611, an expected value calculation portion 612, and a system configuration embodiment portion 613.

In such a configuration, the probability distribution estimation portion 611 estimates the probability distribution for the value of the evaluation index for the embodied system configuration when the system configuration that is a candidate for embodiment is embodied in the system design by embodiment of the system configuration. The expected value calculation portion 612 calculates the expected value of the evaluation index based on the estimated probability distribution. The system configuration embodiment portion 13 selects one of the system configurations that are candidates to be embodied based on the expected values of the evaluation indices, and embodies the selected system configuration.

The probability distribution estimation portion 611 is an example of a probability distribution estimation means. The expected value calculation portion 612 is an example of an expected value calculation means. The system configuration embodiment portion 13 is an example of a system configuration embodiment means.

Thus, it is expected that the system configuration embodiment portion 613, by selecting the system configuration to be embodied based on the expected value of the evaluation index, selects the system configuration to have a high value of the evaluation index for the performance desired by the user. According to the system design device 610, it is expected that the system configuration will be obtained that satisfies the specified constraint conditions in this regard, as well as satisfies the constraint conditions at a relatively high level with respect to the user's desired performance.

### Third Example Embodiment

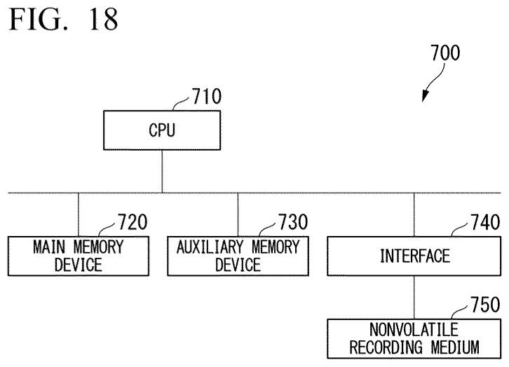

FIG. 17 is a flowchart showing an example of the processing steps in the system design method according to the third example embodiment. The system design method shown in FIG. 17 includes estimating the probability distribution (Step S611), calculating the expected value (Step S612), and embodying the system configuration (Step S613).

In estimating the probability distribution (Step S611), a computer estimates the probability distribution for the value of the evaluation index for the embodied system configuration when the candidate system configuration to be embodied is embodied in the system design by embodiment of the system configuration.

In calculating the expected value (Step S612), the expected value of the evaluation index is calculated based on the estimated probability distribution.

In embodying the system configuration (Step S613), one of the candidate system configurations to be embodied is selected based on the expected values of the evaluation indices, and the selected system configuration is embodied.

Thus, in the system design method shown in FIG. 17, it is expected that, by selecting the system configuration to be embodied based on the expected value of the evaluation index, the system configuration is selected to have a high value of the evaluation index for the performance desired by the user. According to the system design method shown in FIG. 17, it is expected that the system configuration will be obtained that satisfies the specified constraint conditions in this regard, as well as satisfies the constraint conditions at a relatively high level with respect to the user's desired performance.

FIG. 18 is a schematic block diagram showing the configuration of a computer according to at least one example embodiment.

In the configuration shown in FIG. 18, a computer 700 is provided with a CPU 710, a main memory device 720, an auxiliary memory device 730, an interface 740, and a nonvolatile recording medium 750.

Any one or more of the above system design device 100, the user terminal device 300, and the system design device 610, or any part thereof, may be implemented in the computer 700. In that case, the operations of each of the above-mentioned processing units are stored in the auxiliary memory device 730 in the form of a program. The CPU 710 reads the program from the auxiliary memory device 730, deploys it in the main memory device 720, and executes the above processing according to the program. The CPU 710 also reserves a storage area in the main memory device 720 according to the program. Communication between each device and other devices is performed by the interface 740, which has a communication function and communicates according to the control of the CPU 710. The interface 740 also has a port for the nonvolatile recording medium 750, and thereby reads information from and writes information to the nonvolatile recording medium 750.

When the system design device 100 is implemented in the computer 700, the operations of the configuration information embodiment portion 110 and the configuration evaluation portion 120 are stored in the auxiliary storage device 730 in the form of a program. The CPU 710 reads the program from the auxiliary memory device 730, deploys it in the main memory device 720, and executes the above processing according to the program.

The CPU 710 also allocates the storage area corresponding to the storage portion 130 in the main memory device 720 according to the program.

Communication with other devices by the input/output portion 140 is performed by the interface 740, which has communication functions and operates according to the control of the CPU 710.

The display by the input/output portion 140 is performed by the interface 740 having a display device and displaying various images according to the control of the CPU 710.

Acceptance of a user operation by the input/output portion 140 is performed by the interface 740 accepting the user operation with input devices such as a keyboard and mouse, for example, and outputting information indicating the accepted user operation to the CPU 710.

When the user terminal device 300 is implemented in the computer 700, the operation of the user terminal device 300 is stored in the auxiliary storage device 730 in the form of a program. The CPU 710 reads the program from the auxiliary memory device 730, deploys it in the main memory device 720, and executes the above processing according to the program.

The CPU 710 also reserves a storage area in the main memory device 720 for the user terminal device 300 to perform processing according to the program.

Communication between the user terminal device 300 and other devices is performed by the interface 740, which has a communication function and operates according to the control of the CPU 710.

Interaction between the user terminal device 300 and the user is performed by the interface 740, which has a display device and input device and operates according to the control of the CPU 710.

When the system design device 610 is implemented in the computer 700, the operations of the probability distribution estimation portion 611, the expected value calculation portion 612, and the system configuration embodiment portion 613 are stored in the auxiliary storage device 730 in program form. The CPU 710 reads the program from the auxiliary memory device 730, deploys it in the main memory device 720, and executes the above processing according to the program.

The CPU 710 also allocates storage space in the main memory device 720 for processing by the system design device 610 according to the program.

Communication between the system design unit 610 and other devices is performed by the interface 740, which has communication functions and operates according to the control of the CPU 710.

The interaction between the system design portion 610 and the user is performed by the interface 740, which has a display device and input device and operates according to the control of the CPU 710.

Any one or more of the above programs may be recorded on the nonvolatile recording medium 750. In this case, the interface 740 may read the program from the nonvolatile recording medium 750. The CPU 710 may then directly execute the program read by the interface 740, or it may be stored once in the main memory device 720 or auxiliary memory device 730 and then executed.

A program for executing all or part of the processes performed by the system design device 100, the user terminal device 300, and the system design device 610 may be recorded on a computer-readable recording medium, whereby the processing of each part may be performed by having the program recorded on this recording medium read into a computer system and executed. The term “computer system” here shall include an operating system and hardware such as peripherals.

In addition, “computer-readable recording medium” means a portable medium such as a flexible disk, magneto-optical disk, ROM (Read Only Memory), CD-ROM (Compact Disc Read Only Memory), or other storage device such as a hard disk built into a computer system. The above program may be used to realize some of the aforementioned functions, and may also be used to realize the aforementioned functions in combination with programs already recorded in the computer system.

The above example embodiments of this invention have been described in detail with reference to the drawings. Specific configurations are not limited to these example embodiments, but also include designs, and the like, to the extent that they do not depart from the gist of this invention.

Some or all of the above example embodiments may also be described as, but not limited to, the following Supplementary Notes.

### (Supplementary Note 1)

A system design device provided with a probability distribution estimation means that estimates a probability distribution of values of evaluation indices of an embodied system configuration in cases where system configurations that are candidates to be embodied have been embodied in system design involving embodiment of system configurations;
an expected value calculation means that calculates expected values of the evaluation indices on the basis of the probability distribution; and
a system configuration embodiment means that selects one of the system configurations that is a candidate to be embodied on the basis of the expected values of the evaluation indices, and embodies the selected system configuration.

### (Supplementary Note 2)

The system design device according to Supplementary Note 1, wherein the expected value calculation means calculates the expected value for each of the multiple evaluation indices for one system configuration, and
the system configuration embodiment means weights and sums the expected values for each of the multiple evaluation indices using the weight values set for each evaluation index, and selects one of the system configurations that is a candidate to be embodied based on the obtained total value.

### (Supplementary Note 3)

The system design device as described in Supplementary Note 2, further provided with an input/output means that accepts the setting of the weight value by the user of the system design device.

### (Supplementary Note 4)

The system design device as described in any one of Supplementary Notes 1 to 3, further comprising a fulfillment probability calculation means that calculates the probability of a constraint condition set in regards to the evaluation index holding true based on the probability distribution,
wherein the system configuration embodiment means selects one of the system configurations which is a candidate to be embodied based on the expected value of the evaluation index and the probability that the constraint condition holds true.

### (Supplementary Note 5)

The system design device as described in Supplementary Note 4, further comprising a qualitative condition estimation means that estimates the probability that a qualitative condition in regards to the embodied system configuration holds true when the system configuration which is a candidate to be embodied is embodied,
wherein the system configuration embodiment means selects one of the system configurations that is a candidate to be embodied based on the expected value of the evaluation index, the probability that the constraint condition holds true, and the smallest value among the probabilities that the qualitative condition holds true.

### (Supplementary Note 6)

A system design device as described in any one of Supplementary Notes 1 to 5, further comprising a constraint condition verification means that determines whether or not there is an inconsistency in the constraint conditions set for each evaluation index with respect to the system configuration that is a candidate to be embodied,
wherein the probability distribution estimation means suppresses the estimation of the probability distribution when it is determined that there is an inconsistency in the constraint conditions.

### (Supplementary Note 7)

A display device that displays a user operation area for accepting input of a weight value for each of a plurality of evaluation indices for the system configuration generated by system design.

### (Supplementary Note 8)

A display device that displays an icon for accepting a user operation to indicate whether or not to use at least one of a plurality of evaluation indices for a system configuration generated by system design to evaluate the system configuration.

### (Supplementary Note 9)

A system design method that includes a computer:
estimating a probability distribution of values of evaluation indices of an embodied system configuration in cases where system configurations that are candidates to be embodied have been embodied in system design involving embodiment of system configurations;
calculating expected values of the evaluation indices on the basis of the probability distribution; and
selecting one of the system configurations that is a candidate to be embodied on the basis of the expected values of the evaluation indices.

A system design method that includes a computer

### (Supplementary Note 10)

A recording medium that records a program for causing a computer to execute:
estimating a probability distribution of values of evaluation indices of an embodied system configuration in cases where system configurations that are candidates to be embodied have been embodied in system design involving embodiment of system configurations;
calculating expected values of the evaluation indices on the basis of the probability distribution; and
selecting one of the system configurations that is a candidate to be embodied on the basis of the expected values of the evaluation indices.

### INDUSTRIAL APPLICABILITY

The invention may be applied to a system design device, a display device, a system design method, and a recording medium.

### DESCRIPTION OF REFERENCE SIGNS

1 Design system
100, 610 System design device
110 Configuration information embodiment portion
120 Configuration evaluation portion
121 General evaluation portion
122 Constraint condition verification portion
123 Qualitative condition estimation portion
124 Quantitative condition estimation portion
130 Storage portion
140 Input/output portion
241 Stand-alone evaluation portion
242 AI model selection portion
243 Probability density function parameter calculation portion
244 Probability density function calculation portion
245 Fulfillment probability calculation portion
246, 612 Expected value calculation portion
300 User terminal device
611 Probability distribution estimation portion
613 System configuration embodiment portion

What is claimed is:

1. A system design device comprising:
at least one memory configured to store instructions; and
at least one processor configured to execute the instructions to:
estimate a probability distribution of values of evaluation indices of an embodied system configuration in cases where system configurations that are candidates to be embodied have been embodied in system design involving embodiment of system configurations;
calculate expected values of the evaluation indices on the basis of the probability distribution; and
select one of the system configurations that is a candidate to be embodied on the basis of the expected values of the evaluation indices, and embodies the selected system configuration.

2. The system design device according to claim 1, wherein the expected value is calculated for each of the multiple evaluation indices for one system configuration, and
the expected values are weighted and summed for each of the multiple evaluation indices using the weight values set for each evaluation index, and one of the system configurations that is a candidate to be embodied is selected based on the obtained total value.

3. The system design device according to claim 2, wherein the at least one processor is configured to execute the instructions to accept the setting of the weight value by the user of the system design device.

4. The system design device according to claim 1, wherein the at least one processor is configured to execute the instructions to calculate the probability of a constraint condition set in regards to the evaluation index holding true based on the probability distribution,
wherein one of the system configurations which is a candidate to be embodied is selected based on the expected value of the evaluation index and the probability that the constraint condition holds true.

5. The system design device according to claim 4, wherein the at least one processor is configured to execute the instructions to estimate the probability that a qualitative condition in regards to the embodied system configuration holds true in a case where the system configuration which is a candidate to be embodied is embodied,
wherein one of the system configurations which is a candidate to be embodied is selected based on the expected value of the evaluation index, the probability that the constraint condition holds true, and the smallest value among the probabilities that the qualitative condition holds true.

6. The system design device according to claim 1, wherein the at least one processor is configured to execute the instructions to determine whether or not there is an inconsistency in the constraint conditions set for each evaluation index with respect to the system configuration that is a candidate to be embodied,
wherein the estimation of the probability distribution is suppressed in a case where it is determined that there is an inconsistency in the constraint conditions.

7. A display device that displays a user operation area for accepting input of a weight value for each of a plurality of evaluation indices for the system configuration generated by system design.

8. The display device according to claim 7, further displays an icon for accepting a user operation to indicate whether or not to use at least one of a plurality of evaluation indices for a system configuration generated by system design to evaluate the system configuration.

9. A system design method executed by a computer comprising:
estimating a probability distribution of values of evaluation indices of an embodied system configuration in cases where system configurations that are candidates to be embodied have been embodied in system design involving embodiment of system configurations;
calculating expected values of the evaluation indices on the basis of the probability distribution; and
selecting one of the system configurations that is a candidate to be embodied on the basis of the expected values of the evaluation indices and embodying the selected system configuration.

10. (canceled)
